(19) United States
(12) Patent Application Publication
(10) Pub. No.: US 2023/0093035 A1
(43) Pub. Date: Mar. 23, 2023

(54) INFORMATION PROCESSING DEVICE AND INFORMATION PROCESSING METHOD

(71) Applicant: SONY SEMICONDUCTOR SOLUTIONS CORPORATION, KANAGAWA (JP)

(72) Inventors: KEITA ISHIKAWA, TOKYO (JP); HIROSHI SUMIHIRO, KANAGAWA (JP)

(21) Appl. No.: 17/905,170

(22) PCT Filed: Feb. 24, 2021
(86) PCT No.: PCT/JP2021/006727

§ 371 Date: Aug. 27, 2022

(30) Foreign Application Priority Data
Mar. 5, 2020 (JP) 2020-038034

(51) Int. Cl. G06T 7/11; G06T 5/50; G06V 10/24; G06V 10/74

(52) U.S. Cl. CPC G06T 7/11; G06T 5/50; G06V 10/242; G06V 10/761; G06V 2201/07; G06T 2207/20221

(57) ABSTRACT

An information processing device (2) includes a division unit (322) that divides an input image into a plurality of divided images having the same size, a rotation unit (324) that rotates, according to positions on the input image before the division, the plurality of divided images, and a recognition unit (325) that recognizes the plurality of divided images after the rotation.

### TECHNICAL FIELD

The present disclosure relates to an information processing device and an information processing method.

### BACKGROUND ART

Patent Document 1 (Japanese Patent Application Laid-Open No. 2012-230546) proposes a method for performing object recognition by using a fisheye image as is. With this method, a fisheye image is divided according to a direction of distortion, and each of the divided images is collated with a database, by which an object in the image is recognized.

### CITATION LIST

### Patent Document

Patent Document 1: Japanese Patent Application Laid-Open No. 2012-230546

### SUMMARY OF THE INVENTION

### Problems to be Solved by the Invention

There is still room for improvement in accuracy of recognition of distorted images such as fisheye images. An object of the present disclosure is to provide an information processing device, an information processing method, and an information processing program that are capable of improving accuracy of recognition of a distorted image such as a fisheye image.

### Solutions to Problems

An information processing device according to one aspect of the present disclosure includes a division unit that divides an input image into a plurality of divided images having the same size, a rotation unit that rotates, according to positions on the input image before the division, the plurality of divided images, and a recognition unit that recognizes the plurality of divided images after the rotation.

An information processing method according to one aspect of the present disclosure includes dividing an input image into a plurality of divided images having the same size, rotating, according to positions on the input image before the division, the plurality of divided images, and recognizing the plurality of divided images after the rotation.

### BRIEF DESCRIPTION OF DRAWINGS

FIG. 1 is a diagram illustrating an example of a schematic configuration of an imaging device (one aspect of an information processing device) according to an embodiment.

FIG. 2 is a perspective view illustrating an overview of an example of external configuration of the imaging device.

FIG. 3 is a functional block diagram illustrating an example of a configuration of a DSP.

FIG. 4A is a diagram illustrating an example of image division.

FIG. 4B is a diagram illustrating an example of image division.

FIG. 5A is a diagram illustrating an example of image division.

FIG. 5B is a diagram illustrating an example of image division.

FIG. 6A is a diagram illustrating an example of selection of divided images.

FIG. 6B is a diagram illustrating an example of selection of divided images.

FIG. 7A is a diagram illustrating an example of selection of divided images.

FIG. 7B is a diagram illustrating an example of selection of divided images.

FIG. 8A is a diagram illustrating an example of rotation of a divided image.

FIG. 8B is a diagram illustrating an example of rotation of a divided image.

FIG. 8C is a diagram illustrating an example of rotation of a divided image.

FIG. 8D is a diagram illustrating an example of rotation of a divided image.

FIG. 9 is a diagram illustrating an example of input of divided images to a trained model.

FIG. 10 is a flowchart illustrating an example of recognition processing.

FIG. 11A is a diagram illustrating an example of image division.

FIG. 11B is a diagram illustrating an example of image division.

FIG. 12A is a diagram illustrating an example of image division.

FIG. 12B is a diagram illustrating an example of image division.

FIG. 13A is a diagram illustrating an example of image division.

FIG. 13B is a diagram illustrating an example of image division.

FIG. 14A is a diagram illustrating an example of image division.

FIG. 14B is a diagram illustrating an example of image division.

FIG. 15 is a diagram illustrating an example of a schematic configuration of an imaging device according to a modification.

FIG. 16 is a diagram illustrating an example of a schematic configuration of an imaging device according to a modification.

FIG. 17 is a block diagram illustrating an example of a schematic configuration of a vehicle control system.

FIG. 18 is an explanatory diagram illustrating an example of installation positions of a vehicle exterior information detection unit and an imaging unit.

### MODE FOR CARRYING OUT THE INVENTION

Embodiments of the present disclosure will be described below on the basis of the drawings. Note that, in each of the following embodiments, the same parts are provided with the same reference signs, so that repeated description of these parts is omitted.

The present disclosure will be described in the following item order.

1. Introduction

2. Embodiment

2.1 Configuration example of imaging device (one aspect of

information processing device)

2.2 Example of configuration of DSP

2.3 Example of image recognition processing

3. Modifications

4. Effects

5. Examples of application to mobile object

### 1. Introduction

By using a fisheye/omnidirectional camera, an image of a wide range can be captured at a time. Because the captured image (for example, a circumferential image) is distorted, image conversion is usually performed to recognize, detect, or the like an object or a person. However, because the processing is heavy, there is also a need for using a distorted image as is. In that case, recognition/detection accuracy deteriorates, and a memory amount or a calculation amount increases if a plurality of recognition units is provided in order to solve the deterioration. It is desired to achieve a high-speed and low-consumption memory with high recognition/detection accuracy.

Although not essential, in one aspect of the present disclosure, a neural network (NN) for human detection or object detection trained by using a distorted circumferential image is used. In a case where an image divided into n is used as an input image by utilizing rotational symmetry of a circumferential image, an NN having an input resolution when the image is divided into n is trained by using a set of training data divided into n. At a time of inference, an image to be inferred is divided into n in the same manner as the trained number n of divisions, rotated, and input to a pre-trained NN for division into n number to perform image recognition (including object detection, or the like). With this arrangement, as will be described later, recognition accuracy is improved. Furthermore, by dividing the image, the NN can be reduced in scale as compared with a case where the image is not divided. Accordingly, low-consumption memory and high speed are achieved.

### 2. Embodiment

2.1 Configuration Example of Imaging Device (One Aspect of Information Processing Device)

Hereinafter, an imaging device according to an embodiment will be described. In the following embodiment, the imaging device is an electronic apparatus such as a camera, and is also an information processing device that performs signal processing on acquired image data. The camera may be a fisheye lens camera. However, the imaging device is not limited to such an electronic apparatus.

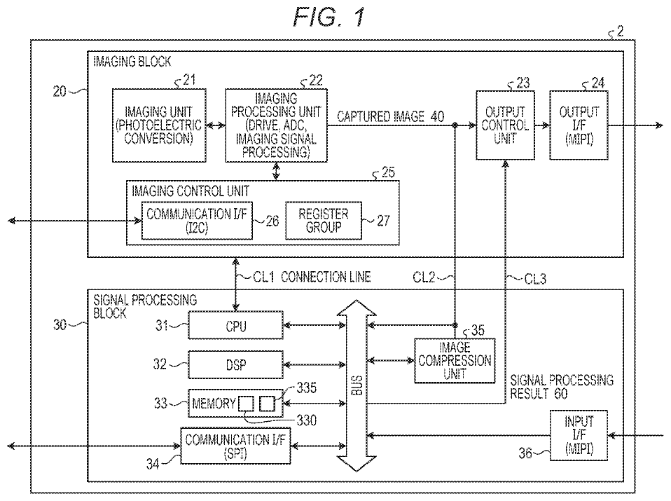

FIG. 1 is a block diagram illustrating a configuration example of the imaging device. An imaging device 2 includes an imaging block 20 and a signal processing block 30. The imaging block 20 and the signal processing block 30 are connected by connection lines CL1 to CL3.

The imaging block 20 generates image data by executing imaging operation. The imaging block 20 includes an imaging unit 21, an imaging processing unit 22, an output control unit 23, an output I/F 24, and an imaging control unit 25.

The imaging unit 21 includes a plurality of two-dimensionally arranged pixels. When light from an optical system (not illustrated) is incident on the imaging unit 21, photoelectric conversion is performed in each pixel, and an analog pixel signal corresponding to the incident light is output.

The imaging processing unit 22 drives the imaging unit 21. Furthermore, the imaging processing unit 22 converts the analog pixel signal from the imaging unit 21 into a digital pixel signal, and outputs, as a captured image 40, a pixel signal for one frame converted into digital. The captured image 40 is sent to the output control unit 23, and sent to the signal processing block 30 via a connection line CL2. The captured image 40 may be one frame in a moving image. In a case where the imaging device 2 is a fisheye lens camera, the captured image 40 may be a fisheye image. The fisheye image may be a circumferential fisheye image.

The output control unit 23 outputs the captured image 40 from the imaging processing unit 22 and/or a signal processing result 60 (described later) from the signal processing block 30 to an outside via the output I/F 24.

The output I/F 24 is an I/F that outputs the captured image 40 and the signal processing result 60 to the outside. For example, a relatively high-speed I/F such as a mobile industry processor interface (MIPI) may be adopted as the output I/F 24.

The imaging control unit 25 includes a communication I/F 26 and a register group 27. With the outside of the imaging device 2, the communication I/F 26 exchanges necessary information such as information to be read from and written to the register group 27. For example, a first communication I/F such as a serial communication I/F such as an inter-integrated circuit (I2C) may be adopted as the communication I/F 26. The register group 27 stores information regarding imaging by the imaging unit 21 and various other information.

The imaging control unit 25 controls the imaging processing unit 22 according to the imaging information stored in the register group 27, thereby controlling imaging of an image in the imaging unit 21. The imaging control unit 25 is connected to a CPU 31 of the signal processing block 30 via the connection line CL1. Reading and writing of information from and to the register group 27 may be performed by the CPU 31.

The signal processing block 30 performs predetermined signal processing by using the captured image 40 obtained by the imaging block 20, or the like. The signal processing block 30 includes a central processing unit (CPU) 31, a digital signal processor (DSP), a memory 33, a communication I/F 34, an image compression unit 35, an input I/F 36, and a difference generation unit 37. These components of the signal processing block 30 are connected to each other via a bus and exchange information as necessary.

The CPU 31 executes a program to function as an imaging information calculation unit that calculates imaging information by using the signal processing result 60 obtained by the signal processing in a DSP 32. The CPU 31 feeds back and stores the calculated imaging information to the register group 27 of the imaging control unit 25 via the connection line CL1.

The DSP 32 executes the program stored in the memory 33 to perform signal processing using the captured image 40 supplied from the imaging processing unit 22 to the signal processing block 30 via the connection line CL2, and information received from the outside by the input I/F 36.

The memory 33 includes a static random access memory (SRAM), a dynamic RAM (DRAM), or the like, and stores a program or the like necessary for processing by the signal processing block 30. A program necessary for operation of the imaging device 2, a trained model 330 to be described later, and an information processing program 335 are also stored in the memory 33.

The communication I/F 34 is, for example, a second communication I/F such as a serial communication I/F of a serial peripheral interface (SPI), and the like, and exchanges, with the outside, necessary information such as a program executed by the CPU 31 and DSP 32.

The captured image 40 is supplied from the imaging processing unit 22 to the image compression unit 35 via the connection line CL2. The image compression unit 35 performs compression processing for compressing the captured image 40, and generates a compressed image having a small amount of data as compared with the captured image 40. The generated compressed image is supplied to the bus. Note that an uncompressed image that is not compressed by the image compression unit 35 may be supplied to the bus. Hereinafter, a compressed image and an uncompressed image are both referred to as a captured image 40 unless otherwise specified.

The input I/F 36 is an I/F that receives information from the outside. The input I/F 36 receives, for example, output (external sensor output) of an external sensor from the external sensor, supplies the output to the memory 33 via a bus to cause the memory 33 to store the output.

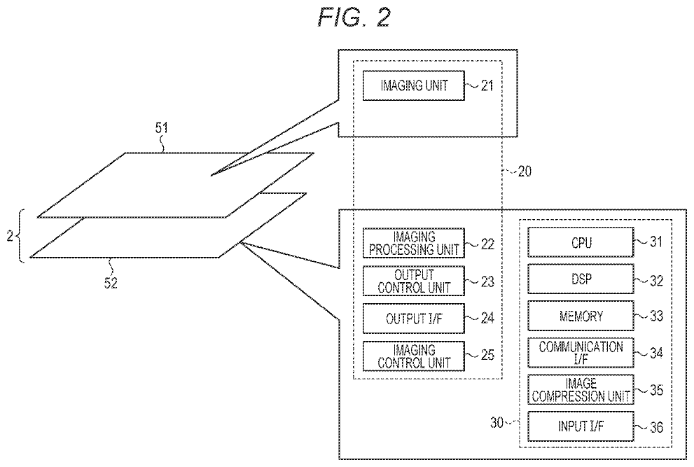

FIG. 2 is a perspective view illustrating an overview of an example of external configuration of the imaging device 2 in FIG. 1.

For example, as illustrated in FIG. 2, the imaging device 2 can be configured as a one-chip semiconductor device having a stacked structure in which a plurality of dies is stacked.

In FIG. 2, the imaging device 2 is configured by stacking two dies that are dies 51 and 52.

In FIG. 2, the imaging unit 21 is mounted on the die 51 on an upper side, and the imaging processing unit 22 to the imaging control unit 25, and the CPU 31 to the input I/F 36 are mounted on the die 52 on a lower side.

The die 51 on the upper side and the die 52 on the lower side are electrically connected by, for example, forming a through hole that penetrates the die 51 and reaches the die 52, performing Cu—Cu bonding for directly connecting Cu wiring exposed on a lower surface side of the die 51 and Cu wiring exposed on an upper surface side of the die 52, or the like.

Here, in the imaging processing unit 22, as a method for performing AD conversion of an image signal output from the imaging unit 21, for example, a column-parallel AD method or an area AD method can be adopted.

In the column-parallel AD method, for example, an AD converter (ADC) is provided for a column of pixels that constitute the imaging unit 21, and the ADC in each column is in charge of pixel signal AD conversion of the pixels in the column, by which AD conversion of the image signals of the pixels in the respective columns is performed in parallel for one row. In a case where the column-parallel AD method is adopted, a part of the imaging processing unit 22 that performs AD conversion using the column-parallel AD method may be mounted on the die 51 on the upper side.

In the area AD method, pixels that constitute the imaging unit 21 are separated into a plurality of blocks, and an ADC is provided for each block. Then, the ADC of each block is in charge of AD conversion of the pixel signals of the pixels of the block, by which AD conversion of image signals of the pixels of the plurality of blocks is performed in parallel. In the area AD method, AD conversion (reading and AD conversion) of an image signal can be performed only for necessary pixels among pixels that constitute the imaging unit 21 with a block as a smallest unit.

Note that, if an area of the imaging device 2 is allowed to be larger, the imaging device 2 can be configured with one die.

Furthermore, although the two dies 51 and 52 are stacked to configure a one-chip imaging device 2 in FIG. 2, the one-chip imaging device 2 can be configured with three or more stacked dies. For example, in a case where three dies are stacked to configure the one-chip imaging device 2, the memory 33 in FIG. 2 can be mounted on another die.

Here, an imaging device in which a sensor chip, a memory chip, and a DSP chip are connected to each other in parallel with a plurality of bumps (hereinafter, also referred to as a bump-connected imaging device) is much thicker than the one-chip imaging device 2 configured in a stacked structure, and therefore is larger in size.

Moreover, in the bump-connected imaging device, due to signal deterioration or the like at a connection part of a bump, it may be difficult to secure a sufficient rate as a rate at which a captured image is output from the imaging processing unit 22 to the output control unit 23.

According to the imaging device 2 having the stacked structure, it is possible to prevent the above-described increase in size of the device and inability to secure a sufficient rate as a rate between the imaging processing unit 22 and the output control unit 23.

Therefore, according to the imaging device 2 having the stacked structure, it is possible to achieve downsizing of an imaging device that outputs information required by a user.

In a case where the information required by the user is a captured image, the imaging device 2 can output the captured image.

Furthermore, in a case where the information required by the user is obtained by signal processing using the captured image, the imaging device 2 can, by performing the signal processing in the DSP 32, obtain and output a signal processing result as information required by the user.

As the signal processing performed by the imaging device 2, that is, the signal processing by the DSP 32, for example, recognition processing for recognizing a predetermined recognition target from a captured image can be adopted.

Furthermore, for example, the imaging device 2 can receive, with the input I/F 36, output of a distance sensor such as a time of flight (ToF) sensor disposed to have a predetermined positional relationship with the imaging device 2. In this case, it is possible to adopt, as the signal processing by the DSP 32, fusion processing for integrating the output from the distance sensor and the captured image to obtain an accurate distance, such as, for example, processing for removing, by using the captured image, noise in the distance image obtained from the output from the distance sensor received by the input I/F 36.

Moreover, for example, with the input I/F 36, the imaging device 2 can receive an image output by an image sensor disposed to have a predetermined positional relationship with the imaging device 2. In this case, as the signal processing by the DSP 32, for example, it is possible to adopt self-localization processing (simultaneously localization and mapping (SLAM)) using the image received by the input I/F 36 and the captured image as stereo images.

In the imaging device 2 having the above configuration, the captured image 40 acquired by the imaging block 20 can be processed by the signal processing block 30, and the signal processing result 60 serving as the processing result can be output to an element (including an AP or the like) outside the imaging device 2. The processing of the signal processing block 30 in the present embodiment includes recognition processing on the captured image 40. In one embodiment, the recognition processing is executed by the DSP 32. Hereinafter, an example of such a form will be described.

2.2 Example of Configuration of DPS

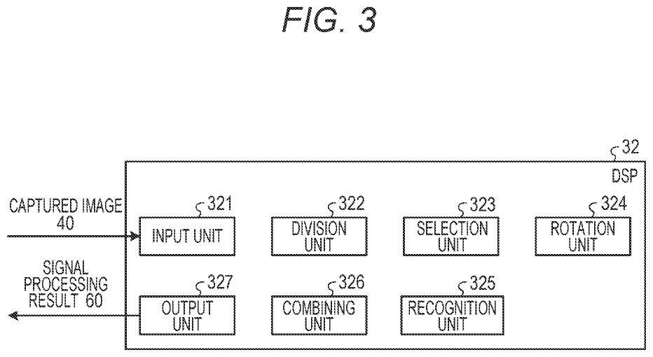

FIG. 3 is a functional block diagram illustrating an example of a configuration of the DSP 32. The DSP 32 includes an input unit 321, a division unit 322, a selection unit 323, a rotation unit 324, a recognition unit 325, a combining unit 326, and an output unit 327.

The captured image 40 (input image) is input to the input unit 321. The input unit 321 acquires the captured image 40 from the imaging block 20 via the bus (FIG. 1).

The division unit 322 divides the captured image 40. The division unit 322 divides the captured image 40 into a plurality of divided images having the same size. The same size means that in a case where the plurality of divided images is aligned in a predetermined orientation, the respective divided images have an identical shape. The predetermined orientation is an orientation of when one divided image among the plurality of divided images is rotated and moved to a position of another divided image on the captured image 40.

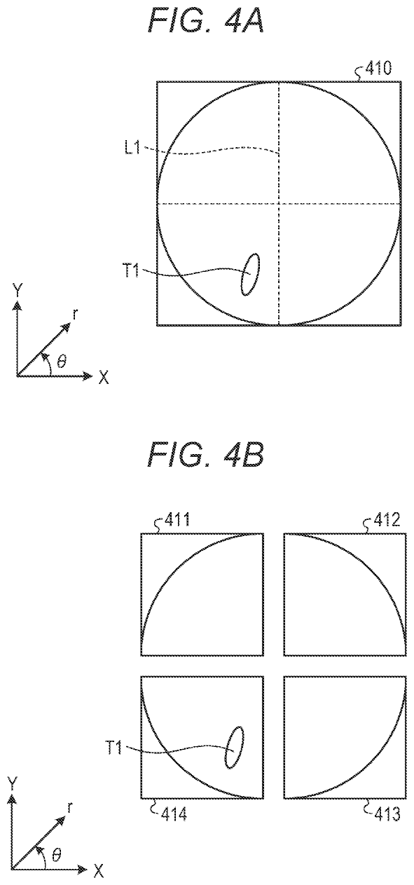

FIGS. 4A and 4B are diagrams illustrating an example of image division. A captured image 410 exemplified is, for example, a circumferential fisheye image having rotational symmetry, and is divided into four divided images 411 to 414. An object T1 such as a human or an object is included in a divided image 414. As illustrated in FIG. 4A, the captured image 410 is divided along division lines L1 (indicating all linear broken lines in the drawing). The division lines L1 extend in a predetermined direction such that each divided image has the same size.

In the example in FIG. 4A, the division lines L1 include four division lines extending along a direction from the center of the captured image 410 toward the outside. Because a degree of distortion of a circumferential fisheye image changes from the center toward an outside, the divided images 411 to 414 obtained by the division lines L1 have substantially the same degree of distortion at corresponding positions in each divided image. For convenience of description, plane coordinates (X, Y) and polar coordinates (r, θ) are illustrated in the figure. An r direction corresponds to a radial direction of the circumferential fisheye image. θ corresponds to a circumferential direction of the circumferential fisheye image. When viewed in the polar coordinates, the division lines L1 adjacent to each other in a θ direction extend in directions different from each other by 90 degrees (360 degrees/the number of divisions).

Returning to FIG. 3, the division unit 322 may set the number of divisions for the captured image 40. The number of divisions is an integer n of 2 or more. For example, the number of divisions may be statically set, and in this case, the division unit 322 may set a number designated by a predetermined parameter as the number of divisions.

The number of divisions may be dynamically set. For example, the division unit 322 may analyze the captured image 40 input to the input unit 321 and set the number of divisions on the basis of the analysis result. An example of the analysis result of the captured image 40 is resolution of the captured image 40. In addition to the resolution of the captured image 40, the division unit 322 may set an appropriate number of divisions on the basis of a memory size of the imaging device 2, a required processing speed, or the like.

The division unit 322 may set the number of divisions on the basis of a recognition result (object detection result or the like) from the recognition unit 325. A result of recognition by the recognition unit 325 may be a recognition result of the captured image 40 of a current frame, or may be a recognition result of the captured image 40 of a previous frame. For example, the recognition unit 325 may set the number of divisions such that the number of divisions increases as the number of objects in the captured image 40 decreases. With this arrangement, if the number of divisions increases and a size of the divided image decreases, a proportion of the object to the divided image increases accordingly. Therefore, accuracy of recognition of the object by the recognition unit 325 is improved.

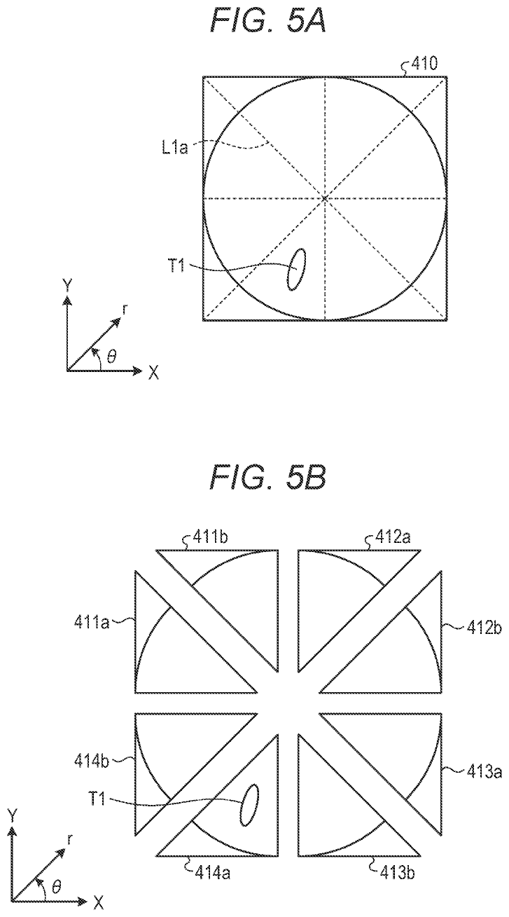

FIGS. 5A and 5B are diagrams illustrating an example of division as described above. In this example, the captured image 410 is divided into eight images, that is, a divided image 411a, a divided image 411b, a divided image 412a, a divided image 412b, a divided image 413a, a divided image 413b, a divided image 414a, and a divided image 414b along division lines Lia. The object T1 is included in the divided image 414a. Because a size of the divided image 414a is half a size of the divided image 414 (FIG. 4B), a proportion of the object T1 to the divided image 414a is twice a proportion of the object T1 in the divided image 414 (FIG. 4B).

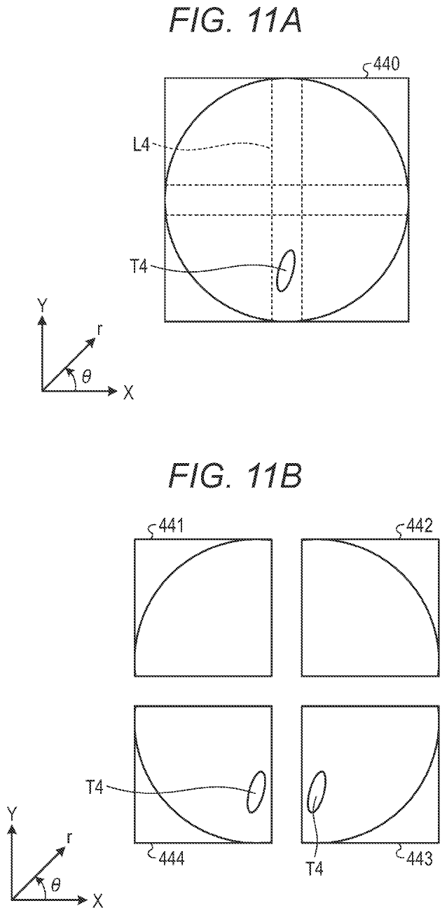

There are various other modes of division, which will be described later with reference to FIG. 11A and subsequent figures.

Returning to FIG. 3, the selection unit 323 selects a plurality of divided images obtained by the division unit 322. Here, the selection by the selection unit 323 includes selecting divided images to be a target of recognition by the recognition unit 325 (which may include a target of rotation by the rotation unit 324) from among the plurality of divided images, excluding a divided image that is not the target of recognition by the recognition unit 325 from the plurality of divided images, and giving priority for recognition by the recognition unit 325 to the plurality of divided images.

The divided images may be statically selected. In this case, the selection unit 323 may select, for example, divided images corresponding to predetermined positions (specific quadrants or the like) in the image.

The divided images may be dynamically selected. In this case, the selection unit 323 may select a plurality of divided images on the basis of the result of recognition by the recognition unit 325. For example, on the basis of the result of recognition by the recognition unit 325, the selection unit 323 may select divided images including a predetermined object. On the basis of the result of recognition by the recognition unit 325, the selection unit 323 may exclude divided images including a predetermined object. On the basis of the result of recognition by the recognition unit 325, the selection unit 323 may give higher priority to divided images including a predetermined object than to other divided images. On the basis of the result of recognition by the recognition unit 325, the selection unit 323 may give higher priority to divided images including an object present within a predetermined range from the imaging device 2 than to other divided images.

Describing a specific example, for example, in a case where the captured image 40 is an image obtained by capturing an image of the same place for a long period of time, a plurality of divided images may be selected such that an object of which image is less necessary to be recognized is excluded from targets of recognition in the selection unit 323 or is given low priority for recognition by the selection unit 323. Examples of such a use case include a SmartHome display. Because the SmartHome display is disposed in, for example, a living room or the like and monitors a human, an animal, or the like around the SmartHome display, it is less necessary to recognize objects other than the human, the animal, or the like.

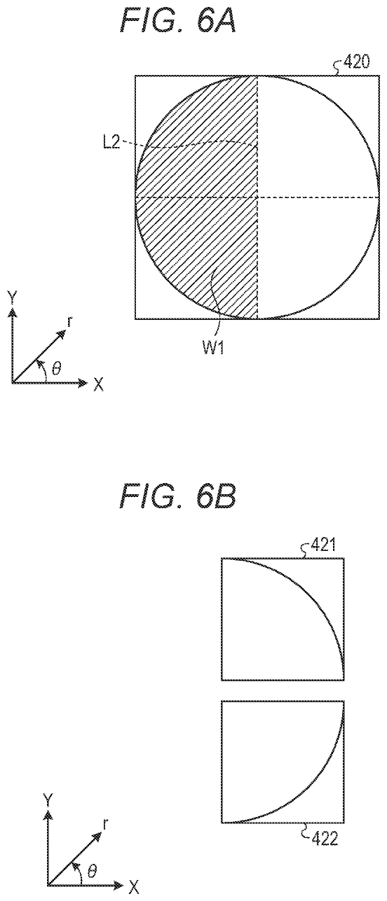

FIGS. 6A and 6B are diagrams illustrating an example of selection of divided images as described above. A left half of a captured image 420 divided into four by division lines L2 is occupied by a wall W1. In this case, the selection unit 323 selects a part of the captured image 420 except for a part occupied by the wall W1, that is, the selection unit 323 selects a divided image 421 and a divided image 422 that are positioned on a right half of image.

Examples other than the SmartHome display are a surveillance camera and a watching camera (for elderly care, infants, or the like). Because the surveillance camera is used, for example, for image recognition of only a vicinity of a door, necessity (priority) of image recognition of a divided image not including the door is low. Similarly, because the watching camera is used, for example, for image recognition of only a vicinity of a bed, necessity (priority) of image recognition of a divided image not including the bed is low.

The divided images may be selected on the basis of information other than the captured image 40. An example of such information is distance information. In this case, the selection unit 323 may select divided images including an object present within a predetermined range (for example, within 1 m) from the imaging device 2. The distance information may be acquired by, for example, a Depth camera. That is, in a case where the imaging device 2 has a function of a Depath camera or is configured to be able to utilize information from the Depath camera, only divided images including an object present within a predetermined range (for example, within 1 m) from the imaging device 2 can be selected.

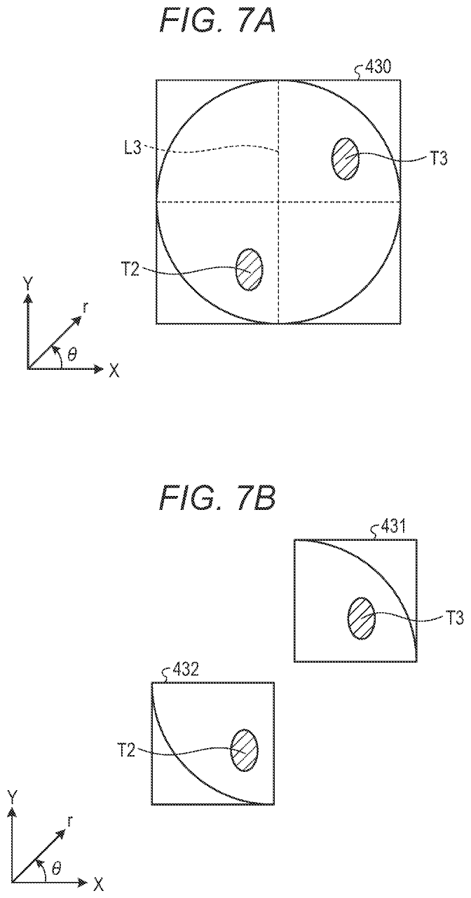

FIGS. 7A and 7B are diagrams illustrating an example of selection of divided images as described above. In a Depth map corresponding to a captured image 430 (one aspect of the captured image 40), objects present within a predetermined range are displayed as objects T2 and T3. In this example, the object T2 is present in a lower left part of the captured image 430 divided into four by division lines L3, and the object T3 is present in an upper right part of the image. There are no objects in other parts of the image. The selection unit 323 selects only parts where objects are present in the captured image 430, that is, the divided images 431 and 432 of the image, or gives a higher priority to the divided images 431 and 432 than to other divided images.

In addition to the distance information, information of an infrared map, a moving object map, a difference image, a dynamic vision sensor (DVS) image, or region of interest (ROI) information may be used. In a case where the information of the infrared map is used, for example, only divided images (quadrants) including an object having a specific infrared intensity or more may be selected. In this case, in the subsequent recognition processing or the like by the recognition unit 325, for example, only an object having a temperature of 37.5 degrees or more can be recognized, and an attribute thereof (is a human, is not a human, is a man, is a woman, is a known person, or the like) can be identified. In a case where the moving object map is used, for example, the recognition processing can be applied only to divided images including the moving objects. By executing the recognition processing only for specific divided images, a processing load can be reduced as compared with a case where all image regions are processed, and a higher frame rate and lower power consumption can be realized.

Returning to FIG. 3, the rotation unit 324 rotates the plurality of divided images such that, for example, gravity directions of the respective divided images are aligned. In a case of a distorted image such as a circumferential fisheye image, the rotation unit 324 rotates the plurality of divided images such that directions in which degrees of distortion of the respective divided images change are aligned. Therefore, the rotation unit 324 rotates each of the plurality of divided images by a predetermined angle according to positions on the captured image 430 before the division. If this is described by using the divided images 411 to 414 illustrated in FIG. 4B, in a case where the divided image 412 is used as a reference for example, the rotation unit 324 rotates the divided image 411 by −90°, rotates the divided image 413 by 90°, and rotates the divided image 414 by 180° in the θ direction. In addition to the divided image 412, any one of the divided image 411, the divided image 413, or the divided image 414 may be used as a reference.

The rotation direction of the divided image may be either a +θ direction or a −θ direction. This is because, for example, in the case of a plurality of divided images obtained from a circumferential fisheye image in which the center of the image is sky/ceiling, a head of a person is positioned on the center side of a circle and feet of the person are positioned on an outer peripheral side of the circle in any of the divided images (quadrants), and therefore, top and bottom are not reversed depending on the rotation direction. Note that, in a case of a circumferential fisheye image in which the center of the image is not sky/ceiling, the divided images may be rotated after being converted into a circumferential fisheye image in which the center of the circle is sky/ceiling by geometric transformation.

The rotation unit 324 may rotate the divided images in the θ direction or, instead, may rotate the divided images around a division line. The rotation around the division line inverts (flips) the divided images. For example, with reference to the divided image 411a and divided image 411b illustrated in FIG. 5B described above, (in a case where the divided image 411a is a reference) the rotation unit 324 may invert the divided image 411b around the division lines L1a (FIG. 5A) so that the divided image 411b is aligned with the divided image 411a.

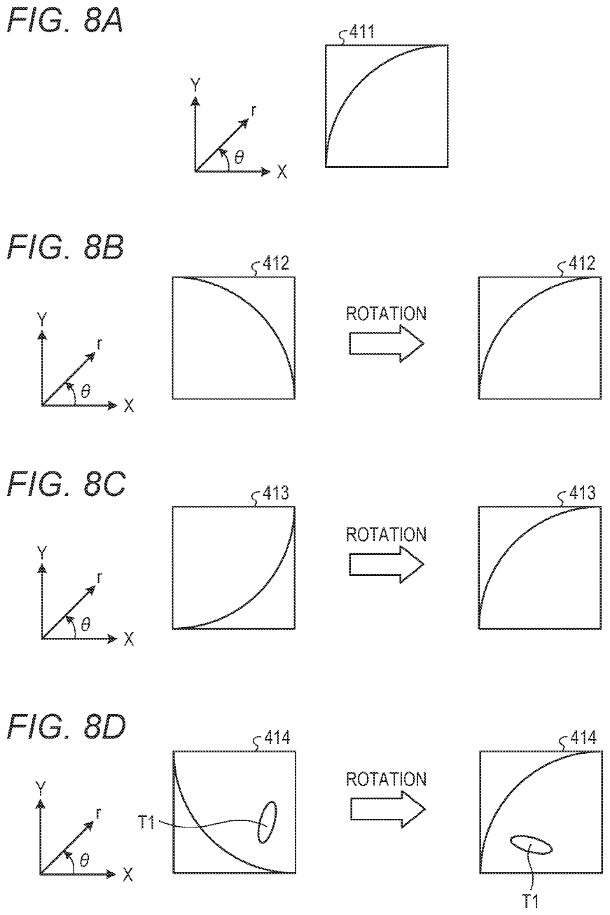

FIGS. 8A to 8D are diagrams illustrating examples of rotation of a divided image. In this example, orientations of the divided images 411 to 414 are aligned with an orientation of the divided image 411. Therefore, without rotating the divided image 411, the rotation unit 324 rotates the divided image 412 by 90° (360°/the number of divisions×1), rotates the divided image 413 by 180° (360°/the number of divisions×2), and rotates the divided image 414 by 270° (360°/the number of divisions×3) in the θ direction.

Returning to FIG. 3, the recognition unit 325 recognizes a plurality of divided images after the rotations. In one embodiment, the recognition unit 325 recognizes, by using the trained model 330, a plurality of divided images after the rotations. The trained model 330 is a trained model generated by using training data so as to output an image recognition result when a divided image is input.

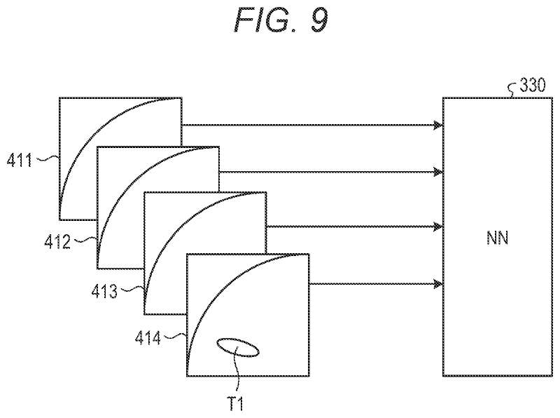

FIG. 9 is an example of a utilization of a trained model. The trained model 330 exemplified in FIG. 9 is a neural network (NN) configured to execute image recognition. Examples of the image recognition by the trained model 330 are classification, object detection, and semantic segmentation, but are not limited thereto. The rotated divided images 411 to 414 are input to the trained model 330. Each of the divided images may be input to the same recognition network. In this case, there is an advantage that the trained model 330 can be configured with a single recognition network, by which a memory size can be saved. The respective divided images may be input to different recognition networks (for example, networks trained to have different parameters). In either case, the trained model 330 outputs (a plurality of) image recognition results corresponding to the respective divided images 411 to 414.

Generation of the trained model 330 may use, for example, a set of training data using, as an input image, a divided image obtained by dividing a circumferential image with distortion (for example, a fisheye circumferential image) into n. The trained model 330 may have an input resolution corresponding to resolution of the divided images divided into n. By preparing a set of training data by using the divided images divided into n, a data set of n times of a case where the division is not performed is obtained.

The recognition unit 325 may recognize the divided images on the basis of a result of selection by the selection unit 323. For example, the recognition unit 325 may input only the divided images selected by the selection unit 323 to the trained model 330. Describing an example of a case where priority is given to the divided images by the selection unit 323, the recognition unit 325 may recognize divided images with high priority with high frequency and recognize divided images with low priority with low frequency. For example, the recognition unit 325 may perform recognition processing as many as five times per second on divided images including a door with many people entering and exiting, and may perform recognition processing only once per second on divided images not including a door. For example, by changing recognition frequency according to priority in this manner, it is possible to allocate a calculation resource to divided images that require high-speed (real-time) recognition processing.

Returning to FIG. 3, the combining unit 326 combines respective recognition results of the plurality of divided images by the recognition unit 325. For example, the combining unit 326 uses the recognition results corresponding to the respective divided images 411 to 414 described above to generate a recognition result similar to a recognition result in a case where image recognition is performed on entire divided images, that is, on the captured image 410.

The output unit 327 outputs the result of the result of recognition by the recognition unit 325 (which may be a result of combination by the combining unit 326). The recognition result output by the output unit 327 is output as the signal processing result 60 (or a part thereof).

The result of recognition by the recognition unit 325 output by the output unit 327 may be fed back for control of the imaging processing unit 22 and imaging unit 21 by the imaging control unit 25 (FIG. 1). For example, the imaging unit 21 may be configured such that pixels can be driven for every pixel region, and in that case, corresponding pixels may be driven such that only a pixel region necessary for recognition is exposed and a pixel region unnecessary for recognition is not exposed. An example of the pixel region necessary for recognition is a pixel region corresponding to an image including an object, and an example of the region for which recognition is unnecessary is a pixel region corresponding to an image including only a wall (such as the wall W1 in FIG. 6A). By turning off pixel drive for the pixel region corresponding to an image that does not need to be recognized (by controlling an exposure pixel region), power consumption of the imaging device 2 can be reduced.

2.3 Example of image recognition processing

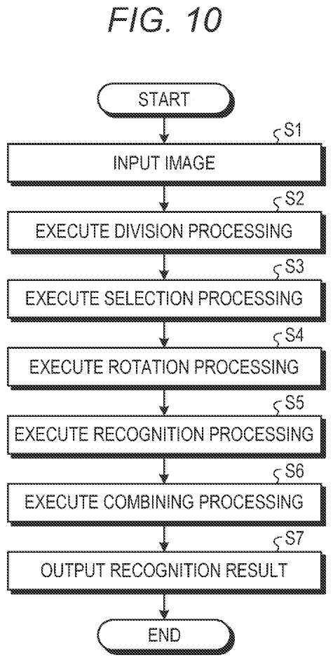

FIG. 10 is a flowchart illustrating an example of image recognition processing executed in the imaging device 2. The image recognition processing is performed by the DSP32 executing the information processing program 335 (FIG. 1) stored in the memory 33.

In Step S1, an image is input. That is, the input unit 321 acquires the captured image 40 from the imaging block 20 via the bus (FIG. 1).

In Step S2, division processing is executed. That is, the division unit 322 divides the captured image 40 acquired in the previous Step S1, as described above with reference to FIGS. 4A, 4B, 5A, and 5B, for example.

In Step S3, selection processing is executed. That is, the selection unit 323 selects a plurality of divided images obtained in the previous Step S2, as described above with reference to FIGS. 6A, 6B, 7A, and 7B, for example.

In Step S4, rotation processing is executed. That is, for example, as described above with reference to FIGS. 8A to 8D, the rotation unit 324 rotates the plurality of divided images selected in Step S3 so that orientations of shapes of the respective divided images are aligned.

In Step S5, recognition processing is executed. That is, for example, as described above with reference to FIG. 9, the recognition unit 325 recognizes the plurality of divided images after being rotated in the previous Step S4.

In Step S6, combining processing is executed. That is, for example, as described above, the combining unit 326 combines respective recognition results of the plurality of divided images obtained in Step S5 described above.

In Step S7, a recognition result is output. That is, the output unit 327 outputs, as the signal processing result 60 (or a part thereof), the recognition result of the captured image 40 obtained in Step S6 described above.

After the processing in Step S7 is completed, the processing in the flowchart ends.

Although the embodiment of the present disclosure have been described above, the embodiment of the present disclosure is not limited to the above-described examples.

### 3. Modifications

Modifications of the mode of division by the division unit 322 will be described.

The captured image may be divided such that adjacent divided images among the plurality of divided images at least partially overlaps (overlaps) each other. With this arrangement, for example, an object present in a boundary region in the division (a region on a division line and a region near the division line) is included in the plurality of divided images, and thus, accuracy of recognition of the object can be improved. In the example illustrated in FIGS. 11A and 11B, a captured image 440 is divided into four divided images 441 to 444 along division lines L4. Each of the divided images partially overlaps all other divided images. An object T4 is present (in this example, without being divided) in a boundary region between the divided image 443 and the divided image 444, and is included in both the divided image 443 and the divided image 444.

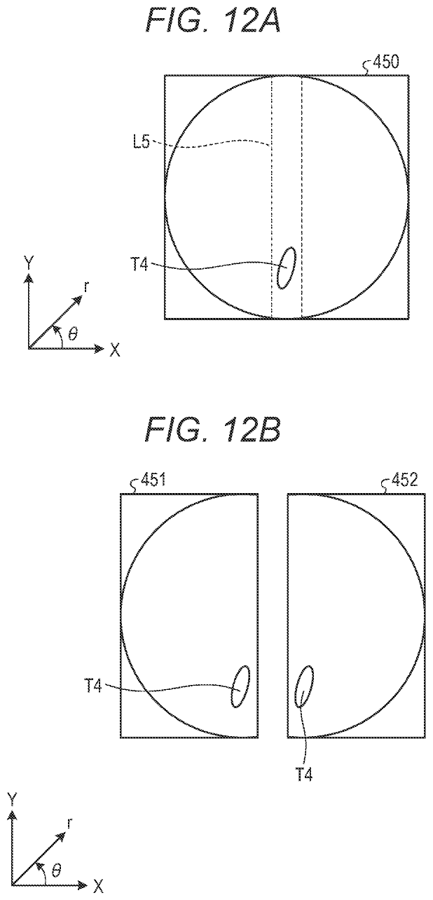

In the example illustrated in FIGS. 12A and 12B, a captured image 450 is divided into two divided images 451 and 452 along division lines L5. The divided images 451 and 452 partially overlap each other. The object T4 is present (in this example, without being divided) in a boundary region between the divided image 451 and the divided image 452, and is included in both the divided image 451 and the divided image 452.

The division lines may extend not along the r direction (the radial direction of the circumferential fisheye image) as described above, but along another direction (for example, an X direction and/or a Y direction).

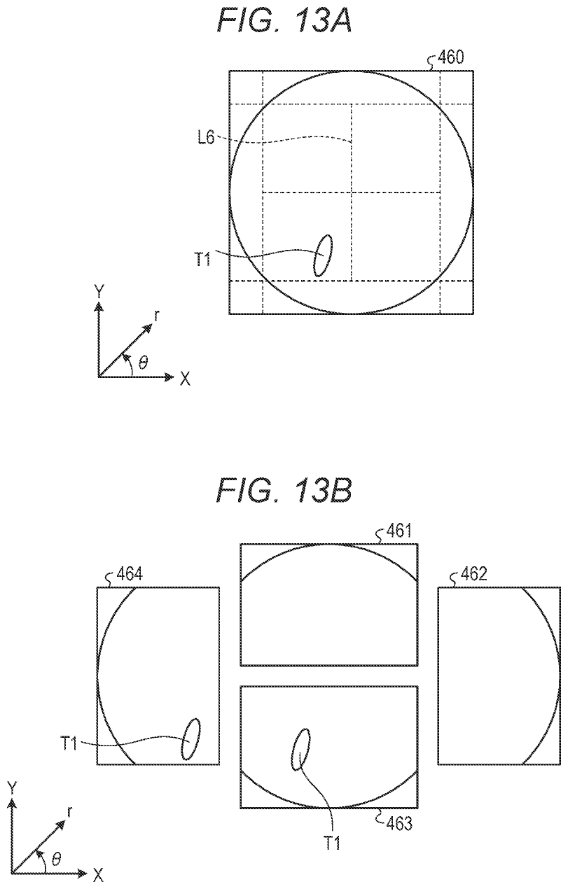

In the example illustrated in FIGS. 13A and 13B, a captured image 460 is divided into four divided images 461 to 464 along division lines L6 (indicating all linear broken lines in the drawing). The division lines L6 extend along an X-axis direction and a Y-axis direction. Each of the divided images partially overlaps some of other divided images. The divided image 461 partially overlaps the divided image 462 and the divided image 464. The divided image 463 partially overlaps the divided image 462 and the divided image 464. The object T1 is included in both the divided image 463 and the divided image 464.

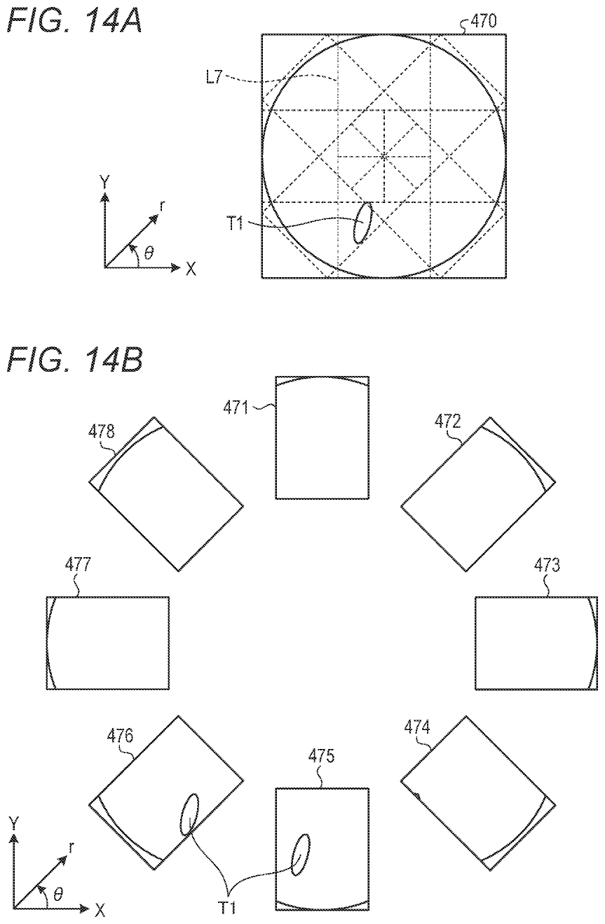

In the example illustrated in FIGS. 14A and 14B, a captured image 470 is divided into eight divided images 471 to 477 along division lines L7. Each of the divided images partially overlaps some of other divided images. The divided image 471 partially overlaps the divided images other than the facing divided image 475, that is, the divided images 472 to 474 and the divided images 476 to 478. A similar applies to the divided images 472 to 478. The object T1 is included in both the divided image 475 and the divided image 476.

In the above embodiment, an example has been described in which image recognition processing on the captured image 40 is executed in the imaging device 2. In this case, there is an advantage that a processing load in a subsequent stage is reduced by performing all the processing in the imaging device 2 and sending only a result of the processing to the subsequent stage, that is, to the outside of the imaging device 2 (an application processor (AP) or the like). There are also advantages that a low-speed IF is sufficient because an amount of information sent is small, it is not necessary to activate an ISP on an AP side, and direct input to a neural network processing unit (NPU) or the like is possible. However, part of the image recognition processing may be executed outside the imaging device 2.

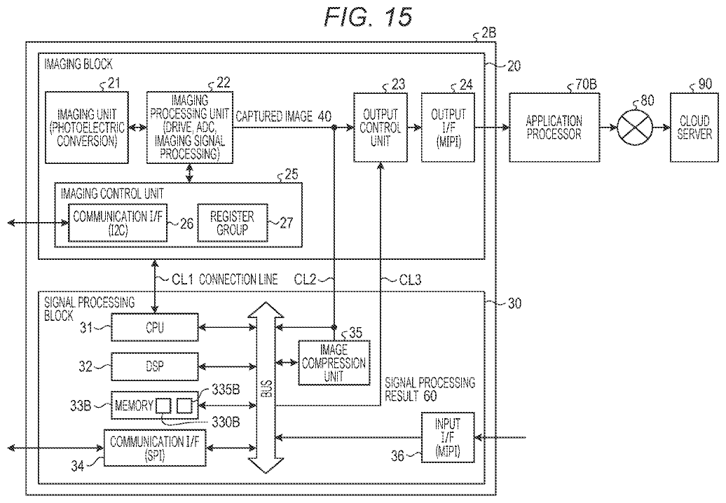

For example, some of functions of the DSP32 may be provided outside the imaging device (provided in a subsequent stage). FIG. 15 is a diagram illustrating an example of a schematic configuration of an imaging device according to such a modification. In an imaging device 2B illustrated in FIG. 15, up to the rotation of the divided images by the rotation unit 324 described above is executed in the imaging device 2B by a trained model 330B and an information processing program 335B that are stored in a memory 33B. The divided images after the rotation are sent to an application processor 70B via the output I/F 24 as the signal processing result 60. The imaging device 2B includes, in the application processor 70B, configurations corresponding to the recognition unit 325 and the combining unit 326. The application processor 70B is configured by using, for example, a central processing unit (CPU) or the like, and executes an operating system, various application software, and the like. The application processor 70B may be equipped with a function such as a graphics processing unit (GPU) or a baseband processor. In addition to detecting an object in the captured image, the application processor 70B executes various processing as necessary on the image data or a machine learning result, executes display to the user, and performs transmission to an external cloud server 90 via a predetermined network 80.

According to the configuration of the imaging device 2B, the application processor 70B can perform recognition processing according to various use cases, and therefore versatility is enhanced.

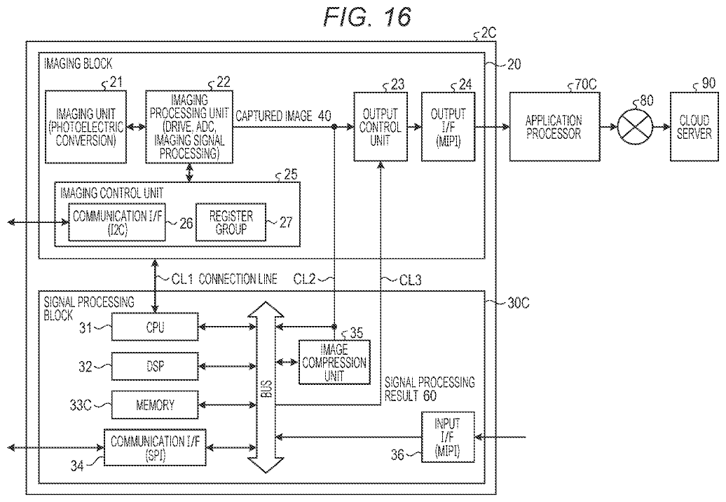

Furthermore, for example, all the object recognition processing may be executed in a subsequent stage in the imaging device. FIG. 16 is a diagram illustrating a schematic configuration of an imaging device according to such a modification. An imaging device 2C illustrated in FIG. 16 is different from the imaging device 2 (FIG. 1) in that a signal processing block 30C is provided instead of the signal processing block 30. The signal processing block 30C does not have the trained model 330 and the information processing program 335 (FIG. 1) in a memory 33C. The imaging device 2C includes, in an application processor 70C, configurations corresponding to the division unit 322, the selection unit 323, the rotation unit 324, the recognition unit 325, and the combining unit 326. That is, in the imaging device 2C, all the image recognition processing is executed by the application processor 70C. In this case, a dedicated imaging device (or DSP) configured to execute the image recognition processing is unnecessary, and the image recognition processing can be achieved by combining a general-purpose imaging device and an application processor.

In the above-described embodiment, an example in which the recognition unit 325 recognizes the divided images by using the trained model 330 has been described. However, the recognition unit 325 may recognize the divided images by using, for example, various established algorithms, without using a trained model.

### 4. Effects

The imaging device 2 (one aspect of the information processing device) described above is specified as follows, for example. As exemplified in FIGS. 1 to 3, the imaging device 2 includes the division unit 322, the rotation unit 324, and the recognition unit 325. As exemplified in FIGS. 4A and 4B, the division unit 322 divides the captured image 40 (input image) into a plurality of divided images 411 to 414 having the same size. As exemplified in FIGS. 8A to 8D, the rotation unit 324 rotates the divided images 411 to 414 according to a position of the captured image 40 before the division. The recognition unit 325 recognizes the divided images 411 to 414 after the rotation.

According to the imaging device 2 described above, after the divided images 411 to 414 of the same size obtained from the captured image 40 are rotated according to the position of the captured image 40 before the division, the divided images are recognized. In this case, in recognition of any of the divided images, divided images of the same size are recognized in a desired orientation. With this arrangement, for example, it is possible to improve accuracy of recognition of the image as compared with a case of recognizing a plurality of divided images of different sizes or in unaligned orientations.

Furthermore, by dividing the image, the NN can be reduced in scale as compared with a case where the image is not divided. Accordingly, low-consumption memory and high speed are achieved.

As exemplified in FIG. 9, the recognition unit 325 may recognize the divided images 411 to 414 after the rotation by using the trained model 330. The trained model 330 may be a trained model generated by using training data so as to output an image recognition result when a divided image is input. By using the trained model 330 corresponding to the divided images in this manner, the image recognition accuracy can be improved.

As exemplified in FIGS. 5A and 5B, the division unit 322 may divide the captured image 40 by the number of divisions according to a result of the recognition by the recognition unit 325. With this arrangement, the captured image 40 can be divided by an appropriate number of divisions corresponding to the captured image 40.

As exemplified in FIGS. 5A and 5B, the recognition unit 325 may detect the object T1 in the divided images 411 to 414. The division unit 322 may divide the captured image 40 with such a division number that the proportion of the object T1 detected by the recognition unit 325 to the divided image 414a is large. With this arrangement, accuracy of recognition of the object T1 can be improved.

As exemplified in FIGS. 11A, 11B, 12A, 12B, 13A, 13B, 14A, and 14B, the division unit 322 may divide the captured image (input image) such that adjacent divided images among the plurality of divided images at least partially overlap each other. With this arrangement, accuracy of recognition of the object T4 present in the boundary region of the division can be improved.

As exemplified in FIG. 3, the imaging device 2 may further include a selection unit 323. As exemplified in FIGS. 6A, 6B, 7A, and 7B, the selection unit 323 may select a plurality of divided images. The recognition unit 325 may recognize the plurality of divided images after the rotation on the basis of the result of selection by the selection unit 323. By selecting divided images to be recognized by the recognition unit 325 in this manner, the recognition processing can be made efficient.

As exemplified in FIGS. 6A, 6B, 7A, and 7B, the selection by the selection unit 323 may include either selecting divided images to be recognized by the recognition unit 325 from a plurality of divided images or excluding a divided image not to be recognized by the recognition unit 325 from the plurality of divided images. With this arrangement, the divided images to be recognized by the recognition unit 325 can be narrowed down, and for example, a burden of the recognition processing can be reduced.

As exemplified in FIGS. 7A and 7B, on the basis of the result of recognition by the recognition unit 325, the selection unit 323 may select divided images including a predetermined object. This is useful, for example, in a case where it is desired to improve accuracy of recognition of the predetermined object.

As exemplified in FIGS. 7A and 7B, the selection unit 323 may select divided images including an object present within a predetermined range from the imaging device 2. This is useful, for example, in a case where it is desired to improve accuracy of recognition of an object present near the imaging device 2 (for example, within 1 m).

As exemplified in FIGS. 6A and 6B, on the basis of the result of recognition by the recognition unit 325, the selection unit 323 may exclude divided images including a predetermined object (for example, the wall W1). This is useful, for example, in a case where the predetermined object is an object that does not need to be recognized.

The selection by the selection unit 323 may give priority for recognition by the recognition unit 325 to the plurality of divided images. With this arrangement, it is possible to improve accuracy of recognition of divided images having a relatively high priority, or to reduce a burden of recognition processing for divided images having a relatively low priority.

On the basis of the result of recognition by the recognition unit 325, the selection unit 323 may give higher priority to divided images including a predetermined object than to other divided images. This is useful, for example, in a case where the predetermined object is an object to be recognized.

The selection unit 323 may give higher priority to divided images including an object present within a predetermined range from the imaging device 2 than to other divided images. This is useful, for example, in a case where it is desired to improve accuracy of recognition of an object present near the imaging device 2 (for example, within 1 m).

On the basis of the result of recognition by the recognition unit 325, the selection unit 323 may give lower priority to divided images including a predetermined object than to other divided images. This is useful, for example, in a case where it is less necessary to recognize the predetermined object.

As exemplified in FIGS. 1 to 3, the imaging device 2 may further include the combining unit 326. The combining unit 326 may combine respective recognition results of the plurality of divided images by the recognition unit 325. With this arrangement, it is possible to obtain a recognition result similar to a recognition result in a case where image recognition is performed on the entire divided images, that is, the input image.

The captured image 40 may be a circumferential fisheye image. As exemplified in FIGS. 4A, 4B, 5A, 5B, 6A, 6B, 7A, 7B, 11A, 11B, 12A, 12B, 13A, 13B, 14A, and 14B, the division unit 322 may divide the captured image along division lines extending outward from the center of the captured image (input image). Because a degree of distortion of a circumferential fisheye image changes from the center toward the outside, the plurality of divided images has substantially the same degree of distortion at corresponding positions in the respective divided images. By recognizing such divided images by the recognition unit 325, recognition accuracy can be improved.

For example, an information processing method illustrated in FIG. 10 is also an embodiment of the present disclosure. That is, the information processing method includes dividing the input image into a plurality of divided images having the same size (Step S2), rotating, according to positions on the input image before the division, the plurality of divided images (Step S4), and recognizing the plurality of divided images after the rotation (Step S5). With such an information processing method also, it is possible to improve the image recognition accuracy similarly to the information processing device described above.

For example, the information processing program 335 stored in the memory 33 illustrated in FIG. 1 is also an embodiment of the present disclosure. That is, the information processing program is a program for causing a computer to function, and causes the computer to execute a step of dividing an input image into a plurality of divided images having the same size (Step S2), a step of rotating, according to positions on the input image before the division, the plurality of divided images (Step S4), and a step of recognizing the plurality of divided images after the rotation (Step S5). With such an information processing method also, it is possible to improve the image recognition accuracy similarly to the information processing device described above.

### 5. Examples of Application to Mobile Object

The technology according to the present disclosure (the present technology) can be applied to various products. For example, the technology according to the present disclosure may be implemented as a device mounted on a mobile object of any kind such as an automobile, an electric vehicle, a hybrid electric vehicle, a motorcycle, a bicycle, a personal mobility, an airplane, a drone, a ship, or a robot.

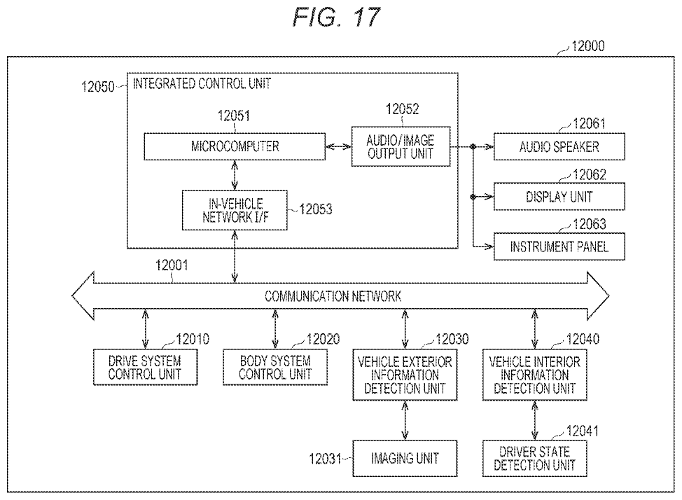

FIG. 17 is a block diagram illustrating an example of schematic configuration of a vehicle control system as an example of a mobile body control system to which the technology according to an embodiment of the present disclosure can be applied.

A vehicle control system 12000 includes a plurality of electronic control units connected via a communication network 12001. In the example depicted in FIG. 17, the vehicle control system 12000 includes a drive system control unit 12010, a body system control unit 12020, a vehicle exterior information detection unit 12030, a vehicle interior information detection unit 12040, and an integrated control unit 12050. In addition, a microcomputer 12051, an audio/image output unit 12052, and an in-vehicle network interface (I/F) 12053 are illustrated as a functional configuration of the integrated control unit 12050.

The drive system control unit 12010 controls the operation of devices related to the driving system of the vehicle in accordance with various kinds of programs. For example, the drive system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls operation of various devices mounted on a vehicle body according to various programs. For example, the body system control unit 12020 functions as a control device for a keyless entry system, a smart key system, a power window device, or various kinds of lamps such as a headlamp, a backup lamp, a brake lamp, a turn signal or a fog lamp. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The vehicle exterior information detection unit 12030 detects information about the outside of the vehicle including the vehicle control system 12000. For example, the vehicle exterior information detection unit 12030 is connected with an imaging unit 12031. The vehicle exterior information detection unit 12030 makes the imaging unit 12031 image an image of the outside of the vehicle, and receives the imaged image. On the basis of the received image, the vehicle exterior information detection unit 12030 may perform processing of detecting an object such as a human, a vehicle, an obstacle, a sign, a character on a road surface, or the like, or processing of detecting a distance thereto.

The imaging unit 12031 is an optical sensor that receives light and outputs an electric signal corresponding to an amount of light received. The imaging unit 12031 can output the electric signal as an image, or can output the electric signal as information about a measured distance. In addition, the light received by the imaging unit 12031 may be visible light, or may be invisible light such as infrared rays or the like.

The vehicle interior information detection unit 12040 detects information about the inside of the vehicle. The vehicle interior information detection unit 12040 is, for example, connected with a driver state detection unit 12041 that detects the state of a driver. The driver state detection unit 12041, for example, includes a camera that images the driver. On the basis of detection information input from the driver state detection unit 12041, the vehicle interior information detection unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the vehicle exterior information detection unit 12030 or the vehicle interior information detection unit 12040, and output a control command to the drive system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automatic driving, which makes the vehicle to travel autonomously without depending on the operation of the driver, or the like, by controlling the driving force generating device, the steering mechanism, the braking device, or the like on the basis of the information about the outside or inside of the vehicle which information is obtained by the vehicle exterior information detection unit 12030 or the vehicle interior information detection unit 12040.

In addition, the microcomputer 12051 can output a control command to the body system control unit 12030 on the basis of the information about the outside of the vehicle which information is obtained by the vehicle exterior information detection unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the vehicle exterior information detection unit 12030.

The audio/image output unit 12052 transmits an output signal of at least one of a sound and an image to an output device capable of visually or auditorily notifying information to an occupant of the vehicle or the outside of the vehicle. In the example of FIG. 10, an audio speaker 12061, a display unit 12062, and an instrument panel 12063 are illustrated as the output device. The display unit 12062 may include, for example, at least one of an onboard display or a head-up display.

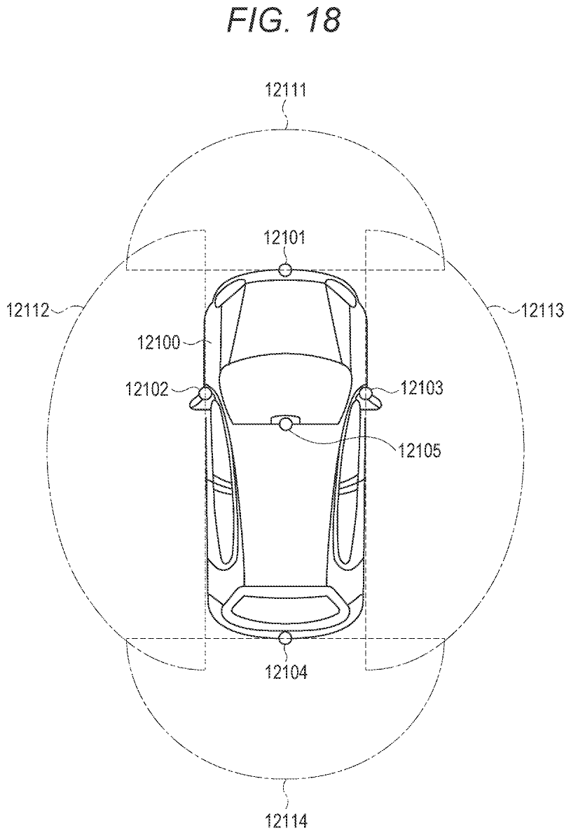

FIG. 18 is a diagram depicting an example of the installation position of the imaging unit 12031.

In FIG. 18, the imaging unit 12031 includes imaging units 12101, 12102, 12103, 12104, and 12105.

The imaging units 12101, 12102, 12103, 12104, and 12105 are provided at positions such as, for example, a front nose, side mirrors, rear bumper, and back door of the vehicle 12100, and an upper part of a front window, or the like, of a vehicle interior of the vehicle 12100. The imaging unit 12101 provided on the front nose and the imaging unit 12105 provided on the upper part of the front window of the vehicle interior mainly acquire an image of a view ahead of the vehicle 12100. The imaging units 12102 and 12103 provided on the side mirrors mainly acquire images of views at sides of the vehicle 12100. The imaging unit 12104 provided on the rear bumper or the back door mainly acquires an image of a rear view of the vehicle 12100. The imaging unit 12105 provided to the upper portion of the windshield within the interior of the vehicle is used mainly to detect a preceding vehicle, a pedestrian, an obstacle, a signal, a traffic sign, a lane, or the like.

Incidentally, FIG. 18 depicts an example of photographing ranges of the imaging units 12101 to 12104. The imaging range 12111 indicates an imaging range of the imaging unit 12101 provided on the front nose, the imaging ranges 12112 and 12113 indicate imaging ranges of the imaging units 12102 and 12103 provided on the side mirrors, respectively, and the imaging range 12114 indicates an imaging range of the imaging unit 12104 provided on the rear bumper or on the back door. A bird's-eye image of the vehicle 12100 as viewed from above is obtained by superimposing image data imaged by the imaging units 12101 to 12104, for example.

At least one of the imaging units 12101 to 12104 may have a function of obtaining distance information. For example, at least one of the imaging units 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging units 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automatic driving that makes the vehicle travel autonomously without depending on the operation of the driver, or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging units 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display unit 12062, and performs forced deceleration or avoidance steering via the drive system control unit 12010. The microcomputer 12051 can thereby assist in driving to avoid collision.

At least one of the imaging units 12101 to 12104 may be an infrared camera that detects infrared rays. The microcomputer 12051 can, for example, recognize a pedestrian by determining whether or not there is a pedestrian in captured images of the imaging units 12101 to 12104. Such recognition of a pedestrian is, for example, performed by a procedure of extracting characteristic points in the captured images of the imaging units 12101 to 12104 as infrared cameras and a procedure of determining whether or not it is the pedestrian by performing pattern matching processing on a series of characteristic points representing the contour of the object. When the microcomputer 12051 determines that there is a pedestrian in the captured images of the imaging units 12101 to 12104, and thus recognizes the pedestrian, the audio/image output unit 12052 controls the display unit 12062 so that a square contour line for emphasis is displayed so as to be superimposed on the recognized pedestrian. Furthermore, the audio/image output unit 12052 may control the display unit 12062 so as to display, at a desired position, an icon or the like indicating a pedestrian.

An example of a vehicle control system to which the technology according to the present disclosure may be applied has been described above. The technology according to the present disclosure may be applied to the imaging unit 12031 among the configurations described above. By applying the technology according to the present disclosure to the imaging unit 12031, a more easily viewable captured image can be obtained, by which fatigue of the driver can be reduced.

Note that the effects described in the present disclosure are merely examples and are not limited to the disclosed content. There may be other effects.

Although the embodiment of the present disclosure has been described above, the technical scope of the present disclosure is not limited to the above-described embodiment as it is, and various modifications are possible without departing from the gist of the present disclosure. Furthermore, components of different embodiments and modifications may be appropriately combined.

Furthermore, the effects on each of the embodiments described herein are only examples, and the effects of the present technology are not limited to these effects. Additional effects may also be obtained.

Note that the present technology can have the following configurations.

(1)

An information processing device including

a division unit that divides an input image into a

plurality of divided images having the same size,

a rotation unit that rotates, according to positions on the input image before the division, the plurality of divided images, and

a recognition unit that recognizes the plurality of divided images after the rotation.

(2)

The information processing device according to (1),

in which the recognition unit recognizes the plurality of divided images after the rotation by using a trained model, and

the trained model includes a trained model generated by using training data so as to output an image recognition result when a divided image is input.

(3)

The information processing device according to (1) or (2),

in which the division unit divides the input image with the number of divisions according to a result of the recognition by the recognition unit.

(4)

The information processing device according to (3),

in which the recognition unit detects an object in the divided images, and

the division unit divides the input image with such a division number that a proportion of the object detected by the recognition unit to a divided image is large.

(5)

The information processing device according to any one of (1) to (4),

in which the division unit divides the input image such that adjacent divided images among the plurality of divided images at least partially overlap each other.

(6)

The information processing device according to any one of (1) to (5), the information processing device further including

a selection unit that selects the plurality of divided images,

in which the recognition unit recognizes the plurality of divided images after the rotation on the basis of a result of the selection by the selection unit.

(7)

The information processing device according to (6),

in which the selection by the selection unit includes either selecting, from the plurality of divided images, a divided image to be recognized by the recognition unit, or excluding, from the plurality of divided images, a divided image not to be recognized by the recognition unit.

(8)

The information processing device according to (7),

in which the selection unit selects a divided image including a predetermined object on the basis of a result of the recognition by the recognition unit.

(9)

The information processing device according to (7),

in which the selection unit selects a divided image including an object present within a predetermined range from the information processing device.

(10)

The information processing device according to (8), in which, on the basis of the result of the recognition by the recognition unit, the selection unit excludes a divided image including a predetermined object.

(11)

The information processing device according to any one of (6) to (10),

in which the selection by the selection unit gives priority for recognition by the recognition unit to the plurality of divided images.

(12)

The information processing device according to (11),

in which, on the basis of the result of the recognition by the recognition unit, the selection unit gives higher priority to a divided image including a predetermined object than to another divided image.

(13)

The information processing device according to (11),

in which the selection unit gives higher priority to a divided image including an object present within a predetermined range from the information processing device than to another divided image.

(14)

The information processing device according to (11),

in which, on the basis of the result of the recognition by the recognition unit, the selection unit gives lower priority to a divided image including a predetermined object than to another divided image.

(15)

The information processing device according to any one of (1) to (14), the information processing device further including

a combining unit that combines respective results of recognition, by the recognition unit, of the plurality of divided images.

(16)

The information processing device according to any one of (1) to (15),

in which the input image is a circumferential fisheye image, and

the division unit divides the input image along division lines extending outward from the center of the input image.

(17)

An information processing method including

dividing an input image into a plurality of divided images having the same size,

rotating, according to positions on the input image before the division, the plurality of divided images, and

recognizing the plurality of divided images after the rotation.

(18)

A program for causing a computer to function, the program causing the computer to execute

a step of dividing an input image into a plurality of divided images having the same size,

a step of rotating, according to positions on the input image before the division, the plurality of divided images, and

a step of recognizing the plurality of divided images after the rotation.

### REFERENCE SIGNS LIST

2 Imaging device
20 Imaging block
21 Imaging unit
22 Imaging processing unit
23 Output control unit
24 Output I/F
25 Imaging control unit
26 Communication I/F
27 Register group
30 Signal processing block
31 CPU
32 DSP
33 Memory
34 Communication I/F
35 Image compression unit
36 Input I/F
40 Captured image
51 Die
52 Die
60 Signal processing result
70 Application processor
80 Network
90 Cloud server
321 Input unit
322 Division unit
323 Selection unit
324 Rotation unit
325 Recognition unit
326 Combining unit
327 Output unit
330 Trained model
335 Information processing program

1. An information processing device comprising:
a division unit that divides an input image into a plurality of divided images having a same size;
a rotation unit that rotates, according to positions on the input image before the division, the plurality of divided images; and
a recognition unit that recognizes the plurality of divided images after the rotation.

2. The information processing device according to claim 1,
wherein the recognition unit recognizes the plurality of divided images after the rotation by using a trained model, and
the trained model includes a trained model generated by using training data so as to output an image recognition result when a divided image is input.

3. The information processing device according to claim 1,
wherein the division unit divides the input image with the number of divisions according to a result of the recognition by the recognition unit.

4. The information processing device according to claim 3,
wherein the recognition unit detects an object in the divided images, and
the division unit divides the input image with such a division number that a proportion of the object detected by the recognition unit to a divided image is large.

5. The information processing device according to claim 1,
wherein the division unit divides the input image such that adjacent divided images among the plurality of divided images at least partially overlap each other.

6. The information processing device according to claim 1, the information processing device further comprising
a selection unit that selects the plurality of divided images,
wherein the recognition unit recognizes the plurality of divided images after the rotation on a basis of a result of the selection by the selection unit.

7. The information processing device according to claim 6,
wherein the selection by the selection unit includes either selecting, from the plurality of divided images, a divided image to be recognized by the recognition unit, or excluding, from the plurality of divided images, a divided image not to be recognized by the recognition unit.

8. The information processing device according to claim 7,
wherein the selection unit selects a divided image including a predetermined object on a basis of a result of the recognition by the recognition unit.

9. The information processing device according to claim 7,
wherein the selection unit selects a divided image including an object present within a predetermined range from the information processing device.

10. The information processing device according to claim 7,
wherein, on a basis of the result of the recognition by the recognition unit, the selection unit excludes a divided image including a predetermined object.

11. The information processing device according to claim 6,
wherein the selection by the selection unit gives priority for recognition by the recognition unit to the plurality of divided images.

12. The information processing device according to claim 11,
wherein, on a basis of the result of the recognition by the recognition unit, the selection unit gives higher priority to a divided image including a predetermined object than to another divided image.

13. The information processing device according to claim 11,
wherein the selection unit gives higher priority to a divided image including an object present within a predetermined range from the information processing device than to another divided image.

14. The information processing device according to claim 11,
wherein, on a basis of the result of the recognition by the recognition unit, the selection unit gives lower priority to a divided image including a predetermined object than to another divided image.

15. The information processing device according to claim 1, the information processing device further comprising
a combining unit that combines respective results of recognition, by the recognition unit, of the plurality of divided images.

16. The information processing device according to claim 1,
wherein the input image is a circumferential fisheye image, and
the division unit divides the input image along division lines extending outward from a center of the input image.

17. An information processing method comprising:
dividing an input image into a plurality of divided images having a same size;
rotating, according to positions on the input image before the division, the plurality of divided images; and
recognizing the plurality of divided images after the rotation.
